(19) United States
(12) Patent Application Publication
(10) Pub. No.: US 2024/0328816 A1
(43) Pub. Date: Oct. 3, 2024

(54) CAMERA LOCALIZATION

(71) Applicants: Ford Global Technologies, LLC, Dearborn, MI (US); The Australian National University, Canberra (AU)

(72) Inventors: Shan Wang, Lawson (AU); Yanhao Zhang, Aranda (AU); Akhil Perincherry, Dearborn, MI (US); Ankit Girish Vora, Northville, MI (US); Hongdong Li, Lyneham (AU); Yujiao Shi, Canberra (AU)

(73) Assignees: Ford Global Technologies, LLC, Dearborn, MI (US); The Australian National University, Canberra (AU)

(21) Appl. No.: 18/191,165

(22) Filed: Mar. 28, 2023

(51) Int. Cl. G01C 21/00; G06T 7/73

(52) U.S. Cl. CPC G01C 21/3811; G01C 21/3841; G01C 21/3852; G06T 7/74; G06T 2207/10032; G06T 2207/20076; G06T 2207/20084; G06T 2207/30244; G06T 2207/30252

(57) ABSTRACT

A computer that includes a processor and a memory, the memory including instructions executable by the processor to determine a first feature map and a first confidence map from a ground view image with a first neural network. First feature points can be determined based on the first feature map and the confidence map. First three-dimensional (3D) feature locations of the first features can be determined based on the first features and the first confidence map. A second feature map and a second confidence map can be determined from an aerial-view image with a second neural network. Second 3D feature locations can be based on the first 3D features, the second feature map and the second confidence map. A three degree-of-freedom (DoF) pose of a ground view camera in global coordinates can be determined by iteratively determining geometric correspondence between the first and second 3D feature locations.

### BACKGROUND

Computers can be used to operate systems including vehicles, robots, drones, and/or object tracking systems. Data including images can be acquired by sensors and processed using a computer to determine a location of a system with respect to objects in an environment around the system. The computer can use the location data to determine trajectories for moving a system in the environment. The computer can then determine control data to transmit to system components to control system components to move the system according to the determined trajectories.

### BRIEF DESCRIPTION OF THE DRAWINGS

FIG. 1 is a block diagram of an example vehicle sensing system.

FIG. 2 is a diagram of an example satellite image including a vehicle.

FIG. 3 is a diagram of another example satellite image including a vehicle.

FIG. 4 is a diagram of example images of a traffic scene acquired by a vehicle.

FIG. 5 is a diagram of example images of a traffic scene including features.

FIG. 6 is a diagram of an example satellite image including features.

FIG. 7 is a diagram of example images of a traffic scene including confidence maps.

FIG. 8 is a diagram of an example satellite image including a confidence map.

FIG. 9 is a diagram of example images of a traffic scene at three resolutions.

FIG. 10 is a diagram of an example image of a traffic scene processed to determine three dimensional locations of features.

FIG. 11 is a diagram of an example system to determine a high-resolution three degree of freedom vehicle location in global coordinates.

FIG. 12 is a flowchart diagram of an example process to determine a high-resolution three degree of freedom vehicle location in global coordinates.

FIG. 13 is a flowchart diagram of an example process to operate a vehicle based on a high-resolution vehicle location in global coordinates.

### DETAILED DESCRIPTION

Sensing systems including vehicles, robots, drones, etc., can be operated by acquiring sensor data regarding an environment around the system and processing the sensor data to determine a path upon which to operate the system or portions of the system. The sensor data can be processed to determine locations of objects in an environment. The objects can include roadways, buildings, conveyors, vehicles, pedestrians, manufactured parts, etc. Sensor data can be processed to determine a pose for the system, where system pose includes a location and an orientation. System pose can be determined based on a full six degree-of-freedom (DoF) pose which includes x, y, and z location coordinates, and roll, pitch, and yaw rotational coordinates with respect to the x, y, and z axes respectively. The six DoF pose can be determined with respect to a global coordinate system such as latitude, longitude, and altitude.

A vehicle is used herein as a non-limiting example of a sensing system. Vehicles can be located with respect to an environment around the vehicle using a simpler three DoF pose that assumes that the vehicle is supported on a planar surface such as a roadway which fixes the z, pitch, and roll coordinates of the vehicle to match the roadway. The vehicle pose can be described by x and y position coordinates and a yaw rotational coordinate to provide a three DoF pose that defines the vehicle location and orientation with respect to a supporting surface.

Vehicle sensors such as a satellite-based global positioning system (GPS) and an accelerometer-based inertial measurement unit (IMU) can provide vehicle pose data that can be used to locate a vehicle with respect to an aerial image that includes location data in global coordinates. The location data included in the aerial image can be used to determine a location in global coordinates of any pixel address location in the aerial image, for example. An aerial image can be obtained by satellites, airplanes, drones, or other aerial platforms. Satellite data will be used herein as an example of aerial image data without loss of generality. For example, be satellite images can be obtained by downloading GOOGLE™ maps or the like from the Internet.

Determining a vehicle pose with respect to satellite image data using global coordinate data included in or with the satellite images can typically provide pose data within +/−3 meters location and +/−3 degrees of orientation resolution. Operating a vehicle may rely on pose data that includes one meter or less resolution in location and one degree or less resolution in orientation. For example, +/−3 meter location data may not be sufficient to determine the location of a vehicle with respect to a traffic lane on a roadway. Techniques for satellite image guided geo-localization as discussed herein can determine vehicle pose within a specified resolution, typically within one meter or less resolution in location and one degree or less resolution in orientation, e.g., a resolution sufficient to operate a vehicle on a roadway. Vehicle pose data determined within a specified resolution, e.g., one meter or less resolution in location and one degree or less resolution in orientation in an exemplary implementation, is referred to herein as high definition pose data.

Techniques described herein employ satellite image guided geo-localization to enhance determination of a high definition pose for a vehicle. Satellite image guided geo-localization uses images acquired by sensors included in a vehicle to determine a high definition pose with respect to satellite images without requiring predetermined high definition (HD) maps. The vehicle sensor images, and the satellite images are input to two separate neural networks which extract features from the images along with confidence maps. In some examples the two separate neural networks can be the same neural network. 3D feature points from the vehicle images are matched to 3D feature points from the satellite images to determine a high definition pose for the vehicle with respect to the satellite image. The high definition pose for the vehicle can be used to operate the vehicle by determining a vehicle path based on the high definition path.

Disclosed herein is a method, including determining a first feature map and a first confidence map from a ground view image with a first neural network. First feature points can be determined based on the first feature map and the confidence map. First three-dimensional (3D) feature locations of the first features can be determined based on the first features and the first confidence map. A second features map and a second confidence map can be determined from an aerial image with a second neural network. The first neural network and the second neural network can share weights which determine the processing performed by the first and second neural networks. Second 3D feature locations can be determined based on the first 3D features, the second feature map and the second confidence map and a high definition estimated three degree-of-freedom (DoF) pose of a ground view camera in global coordinates can be determined by iteratively determining geometric correspondence between the first 3D feature locations and the second 3D feature locations until a global loss function is less than a user determined threshold. The geometric correspondence between pairs of the first 3D feature locations and the second 3D locations can be determined by transforming the first 3D locations based on a geometric projection which begins with an initial estimate of the three DoF pose of the ground view camera. The global loss function can be determined by summing 1) a pose aware branch loss function determined by calculating a triplet loss between a transformed first 3D feature locations and the second 3D feature locations and 2) a recursive pose refine branch loss function determined by calculating a residual between the transformed first 3D feature locations and the second 3D feature locations using a Levenberg-Marquardt algorithm.

The pose aware branch loss function can determine a feature residual based on the determined three DoF pose of the ground view camera and the ground truth three DoF pose. The global loss can be differentiated to determine a direction in which to change the estimated three DoF pose of the ground view camera. The global loss can be differentiated to determine a direction in which to change the three DoF pose of the ground view camera based on recursively minimizing the residual with the Levenberg-Marquardt algorithm followed by determining a re-projection loss based on an estimated pose. The estimated three degree-of-freedom (DoF) pose of the ground view camera in global coordinates can be determined based on the aerial image. The first confidence map can include probabilities that features included in the ground view image are included in a ground plane. The second confidence map can include probabilities that features included in the aerial image are included in a ground plane. The first and second neural networks can be convolutional neural networks that includes convolutional layers and fully connected layers. The aerial image can be a satellite image. One or more reduced resolution images can be generated based on the ground view image at full resolution and the first features are determined by requiring that the first features occur in each of the ground view image at full resolution and the one or more reduced resolutions. An initial estimate for a three DoF pose of the ground view camera can be determined based on vehicle sensor data. The high definition estimated three DoF pose of the ground view camera can be output and used to operate a vehicle.

Further disclosed is a computer readable medium, storing program instructions for executing some or all of the above method steps. Further disclosed is a computer programmed for executing some or all of the above method steps, including a computer apparatus, programmed to determine a first feature map and a first confidence map from a ground view image with a first neural network. First feature points can be determined based on the first feature map and the confidence map. First three-dimensional (3D) feature locations of the first features can be determined based on the first features and the first confidence map. A second features map and a second confidence map can be determined from an aerial image with a second neural network. Second 3D feature locations can be determined based on the first 3D features, the second feature map and the second confidence map and a high definition estimated three degree-of-freedom (DoF) pose of a ground view camera in global coordinates can be determined by iteratively determining geometric correspondence between the first 3D feature locations and the second 3D feature locations until a global loss function is less than a user determined threshold. The geometric correspondence between pairs of the first 3D feature locations and the second 3D locations can be determined by transforming the first 3D locations based on a geometric projection which begins with an initial estimate of the three DoF pose of the ground view camera. The global loss function can be determined by summing 1) a pose aware branch loss function determined by calculating a triplet loss between a transformed first 3D feature locations and the second 3D feature locations and 2) a recursive pose refine branch loss function determined by calculating a residual between the transformed first 3D feature locations and the second 3D feature locations using a Levenberg-Marquardt algorithm.

The instructions can include further instructions wherein the pose aware branch loss function can determine a feature residual based on the determined three DoF pose of the ground view camera and the ground truth three DoF pose. The global loss can be differentiated to determine a direction in which to change the estimated three DoF pose of the ground view camera. The global loss can be differentiated to determine a direction in which to change the three DoF pose of the ground view camera based on recursively minimizing the residual with the Levenberg-Marquardt algorithm followed by determining a re-projection loss based on an estimated pose. The estimated three degree-of-freedom (DoF) pose of the ground view camera in global coordinates can be determined based on the aerial image. The first confidence map can include probabilities that features included in the ground view image are included in a ground plane. The second confidence map can include probabilities that features included in the aerial image are included in a ground plane. The first and second neural networks can be convolutional neural networks that includes convolutional layers and fully connected layers. The aerial image can be a satellite image. One or more reduced resolution images can be generated based on the ground view image at full resolution and the first features are determined by requiring that the first features occur in each of the ground view image at full resolution and the one or more reduced resolutions. An initial estimate for a three DoF pose of the ground view camera can be determined based on vehicle sensor data. The high definition estimated three DoF pose of the ground view camera can be output and used to operate a vehicle.

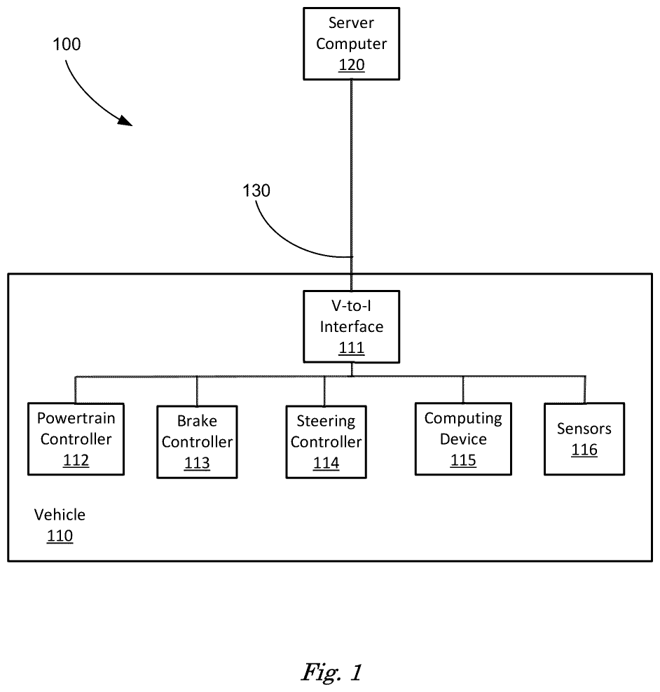

FIG. 1 is a diagram of a sensing system 100. Sensing system 100 includes a vehicle 110, operable in autonomous (“autonomous” by itself in this disclosure means “fully autonomous”), semi-autonomous, and/or occupant piloted (also referred to as non-autonomous) modes, as discussed in more detail below. One or more vehicle 110 computing devices 115 can receive data regarding the operation of the vehicle 110 from sensors 116. The computing device 115 may operate the vehicle 110 in an autonomous mode, a semi-autonomous mode, or a non-autonomous mode. The system 100 can further include a server computer 120 that can communicate with the vehicle 110 via a network 130.

The computing device 115 includes a processor and a memory such as are known. Further, the memory includes one or more forms of computer-readable media, and stores instructions executable by the processor for performing various operations, including as disclosed herein. For example, the computing device 115 may include programming to operate one or more of vehicle brakes, propulsion (i.e., control of acceleration in the vehicle 110 by controlling one or more of an internal combustion engine, electric motor, hybrid engine, etc.), steering, climate control, interior and/or exterior lights, etc., as well as to determine whether and when the computing device 115, as opposed to a human operator, is to control such operations.

The computing device 115 may include or be communicatively coupled to, i.e., via a vehicle communications bus as described further below, more than one computing devices, i.e., controllers or the like included in the vehicle 110 for monitoring and/or controlling various vehicle components, i.e., a propulsion controller 112, a brake controller 113, a steering controller 114, etc. The computing device 115 is generally arranged for communications on a vehicle communication network, i.e., including a bus in the vehicle 110 such as a controller area network (CAN) or the like; the vehicle 110 network can additionally or alternatively include wired or wireless communication mechanisms such as are known, i.e., Ethernet or other communication protocols.

Via the vehicle network, the computing device 115 may transmit messages to various devices in the vehicle and/or receive messages from the various devices, i.e., controllers, actuators, sensors, etc., including sensors 116. Alternatively, or additionally, in cases where the computing device 115 actually comprises multiple devices, the vehicle communication network may be used for communications between devices represented as the computing device 115 in this disclosure. Further, as mentioned below, various controllers or sensing elements such as sensors 116 may provide data to the computing device 115 via the vehicle communication network.

In addition, the computing device 115 may be configured for communicating through a vehicle-to-infrastructure (V2X) interface 111 with a remote server computer 120, i.e., a cloud server, via a network 130, which, as described below, includes hardware, firmware, and software that permits computing device 115 to communicate with a remote server computer 120 via a network 130 such as wireless Internet (WI-FI®) or cellular networks. V2X interface 111 may accordingly include processors, memory, transceivers, etc., configured to utilize various wired and/or wireless networking technologies, i.e., cellular, BLUETOOTH®, Bluetooth Low Energy (BLE), Ultra-Wideband (UWB), Peer-to-Peer communication, UWB based Radar, IEEE 802.11, and/or other wired and/or wireless packet networks or technologies. Computing device 115 may be configured for communicating with other vehicles 110 through V2X (vehicle-to-everything) interface 111 using vehicle-to-vehicle (V-to-V) networks, i.e., according to including cellular communications (C-V2X) wireless communications cellular, Dedicated Short Range Communications (DSRC) and/or the like, i.e., formed on an ad hoc basis among nearby vehicles 110 or formed through infrastructure-based networks. The computing device 115 also includes nonvolatile memory such as is known. Computing device 115 can log data by storing the data in nonvolatile memory for later retrieval and transmittal via the vehicle communication network and a vehicle to infrastructure (V2X) interface 111 to a server computer 120 or user mobile device 160.

As already mentioned, generally included in instructions stored in the memory and executable by the processor of the computing device 115 is programming for operating one or more vehicle 110 components, i.e., braking, steering, propulsion, etc. Using data received in the computing device 115, i.e., the sensor data from the sensors 116, the server computer 120, etc., the computing device 115 may make various determinations and/or control various vehicle 110 components and/or operations. For example, the computing device 115 may include programming to regulate vehicle 110 operational behaviors (i.e., physical manifestations of vehicle 110 operation) such as speed, acceleration, deceleration, steering, etc., as well as tactical behaviors (i.e., control of operational behaviors typically in a manner intended to achieve efficient traversal of a route) such as a distance between vehicles and/or amount of time between vehicles, lane-change, minimum gap between vehicles, left-turn-across-path minimum, time-to-arrival at a particular location and intersection (without signal) minimum time-to-arrival to cross the intersection.

Controllers, as that term is used herein, include computing devices that typically are programmed to monitor and/or control a specific vehicle subsystem. Examples include a propulsion controller 112, a brake controller 113, and a steering controller 114. A controller may be an electronic control unit (ECU) such as is known, possibly including additional programming as described herein. The controllers may communicatively be connected to and receive instructions from the computing device 115 to actuate the subsystem according to the instructions. For example, the brake controller 113 may receive instructions from the computing device 115 to operate the brakes of the vehicle 110.

The one or more controllers 112, 113, 114 for the vehicle 110 may include known electronic control units (ECUs) or the like including, as non-limiting examples, one or more propulsion controllers 112, one or more brake controllers 113, and one or more steering controllers 114. Each of the controllers 112, 113, 114 may include respective processors and memories and one or more actuators. The controllers 112, 113, 114 may be programmed and connected to a vehicle 110 communications bus, such as a controller area network (CAN) bus or local interconnect network (LIN) bus, to receive instructions from the computing device 115 and control actuators based on the instructions.

Sensors 116 may include a variety of devices known to provide data via the vehicle communications bus. For example, a radar fixed to a front bumper (not shown) of the vehicle 110 may provide a distance from the vehicle 110 to a next vehicle in front of the vehicle 110, or a global positioning system (GPS) sensor disposed in the vehicle 110 may provide geographical coordinates of the vehicle 110. The distance(s) provided by the radar and/or other sensors 116 and/or the geographical coordinates provided by the GPS sensor may be used by the computing device 115 to operate the vehicle 110 autonomously or semi-autonomously, for example.

The vehicle 110 is generally a land-based vehicle 110 capable of autonomous and/or semi-autonomous operation and having three or more wheels, i.e., a passenger car, light truck, etc. The vehicle 110 includes one or more sensors 116, the V2X interface 111, the computing device 115 and one or more controllers 112, 113, 114. The sensors 116 may collect data related to the vehicle 110 and the environment in which the vehicle 110 is operating. By way of example, and not limitation, sensors 116 may include, i.e., altimeters, cameras, LIDAR, radar, ultrasonic sensors, infrared sensors, pressure sensors, accelerometers, gyroscopes, temperature sensors, pressure sensors, hall sensors, optical sensors, voltage sensors, current sensors, mechanical sensors such as switches, etc. The sensors 116 may be used to sense the environment in which the vehicle 110 is operating, i.e., sensors 116 can detect phenomena such as weather conditions (precipitation, external ambient temperature, etc.), the grade of a road, the location of a road (i.e., using road edges, lane markings, etc.), or locations of target objects such as neighboring vehicles 110. The sensors 116 may further be used to collect data including dynamic vehicle 110 data related to operations of the vehicle 110 such as velocity, yaw rate, steering angle, engine speed, brake pressure, oil pressure, the power level applied to controllers 112, 113, 114 in the vehicle 110, connectivity between components, and accurate and timely performance of components of the vehicle 110.

Vehicles can be equipped to operate in autonomous, semi-autonomous, or manual modes, as stated above. By a semi- or fully-autonomous mode, we mean a mode of operation wherein a vehicle can be piloted partly or entirely by a computing device as part of a system having sensors and controllers. For purposes of this disclosure, an autonomous mode is defined as one in which each of vehicle propulsion (i.e., via a propulsion including an internal combustion engine and/or electric motor), braking, and steering are controlled by one or more vehicle computers; in a semi-autonomous mode the vehicle computer(s) control(s) one or more of vehicle propulsion, braking, and steering. In a non-autonomous mode, none of these are controlled by a computer. In a semi-autonomous mode, some but not all of them are controlled by a computer.

Server computer 120 typically has features in common, i.e., a computer processor and memory and configuration for communication via a network 130, with the vehicle 110 V2X interface 111 and computing device 115, and therefore these features will not be described further. A server computer 120 can be used to develop and train software that can be transmitted to a computing device 115 in a vehicle 110.

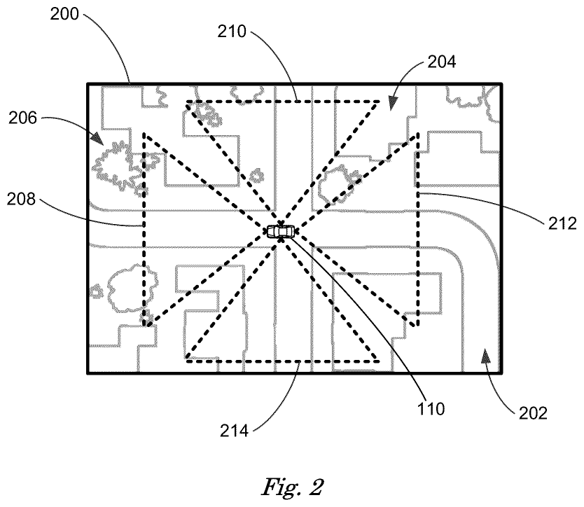

FIG. 2 is a diagram of a satellite image 200. Satellite image 200 can be a map downloaded to a computing device 115 in a vehicle 110 from a source such as GOOGLE maps. Satellite image 200 includes roadways 202, buildings 204, indicated by rectilinear shapes, and foliage 306, indicated by irregular shapes. The version of satellite images 200 used herein is the version that includes photographic likenesses of objects such as roadways 202, buildings 204 and foliage 206. Included in satellite image 200 is a vehicle 110. Vehicle 110 includes sensors 116, including video cameras. Included in satellite image 200 are four fields of view 208, 210, 212, 214 for four video cameras included at the front, right side, back, and left side of the vehicle 110, respectively.

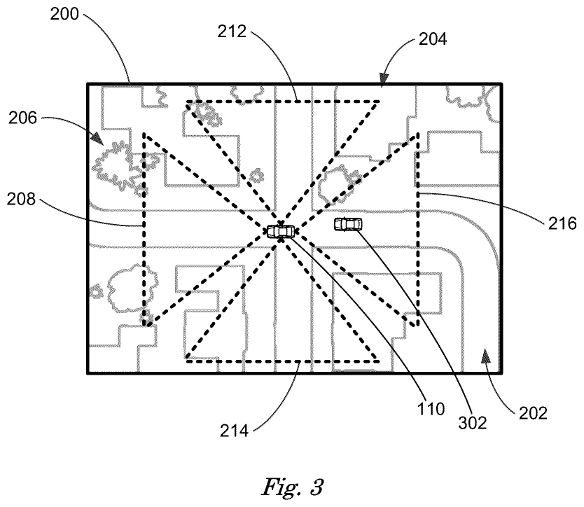

FIG. 3 is a diagram of the satellite image 200 that includes an estimated three DoF pose 302 of vehicle 110. An initial estimated three DoF pose 302 of vehicle 110 with respect to the satellite image 200 can be based on vehicle sensor data including a GPS sensor included in vehicle 110. Because of the limited resolution of GPS sensor and limited resolution of satellite images 200, the estimated three DoF pose 302 of vehicle 110 can be not equal to the true pose of vehicle 110. Because of limited resolutions of GPS sensors and satellite images 200, an estimated three DoF pose 302 cannot be used to operate a vehicle 110.

One solution to the problem of obtaining high definition data for operating vehicles 110 would be to produce HD maps for all areas upon which vehicle 110 operates. High definition maps would require extensive mapping efforts and large amounts of computer resources to produce and store the HD maps, along with large amounts of network bandwidth to download the HD maps to vehicles 110, not to mention the large amount of computer memory required to store the maps in computing devices 115 included in vehicles. Satellite image guided geo-localization techniques described herein use 3D feature points determined based on video images acquired by video cameras included in a vehicle 110 to determine a high definition three DoF pose for a vehicle 110 based on satellite images without requiring the large amount of computer resources required to produce, transmit, and store HD maps.

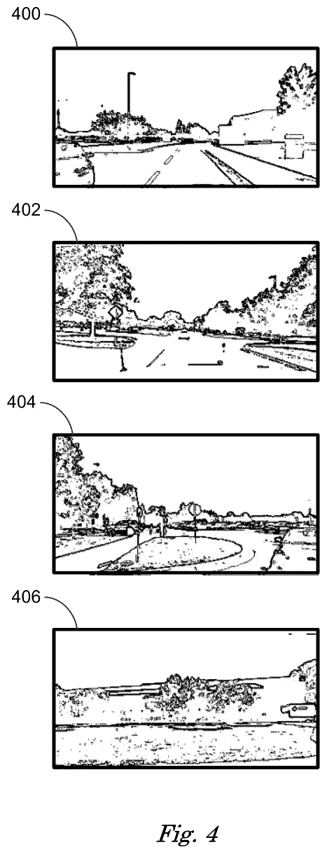

FIG. 4 is a diagram of four images 400, 402, 404, 406 acquired by video cameras included in vehicle 110 indicated by fields of view 208, 210, 212, 214, respectively. Images 400, 402, 404, 406 are red, green, and blue (RGB) color images acquired at standard video resolution, approximately 2K×1K pixels, for example. Images 400, 402, 404, 406 include data from fields of view 208, 210, 212, 214. Satellite image guided geo-localization techniques described herein typically can determine a three DoF pose for a vehicle 110 that is within one meter in x, y location and one degree of yaw orientation, which is more accurate than the 3+ meter location and 3+ degree orientation accuracy of an estimated three DoF pose 302. Satellite image guided geo-localization techniques determine a three DoF pose for a vehicle 110 by determining locations of fields of view 208, 210, 212, 214 with respect to a satellite image 200 by extracting 3D feature points from images and matching them to 3D feature points extracted from a satellite image 200.

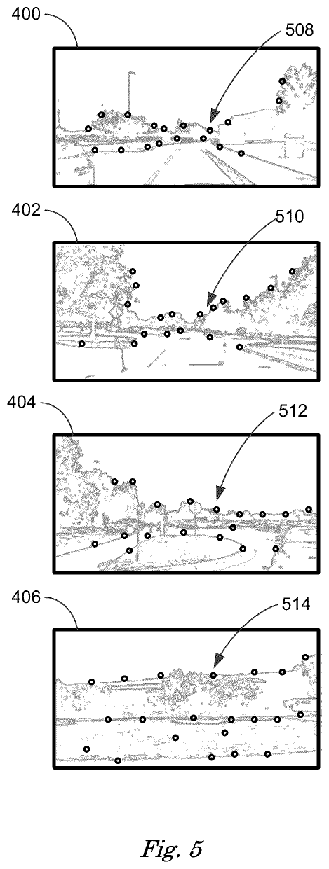

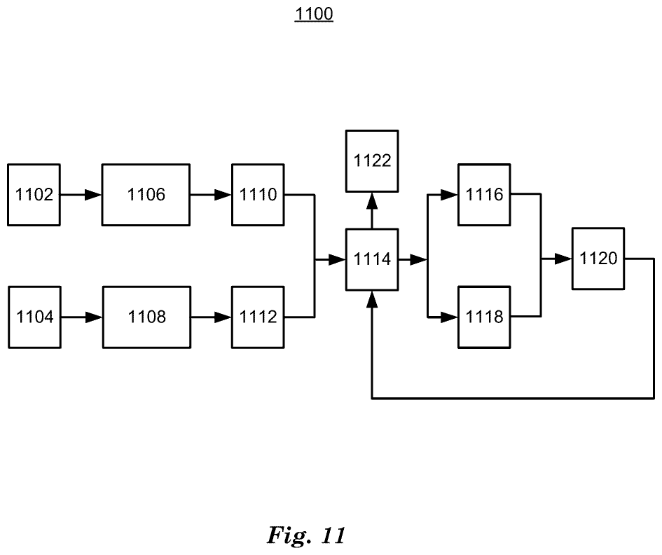

FIG. 5 is a diagram of four images 400, 402, 404, 406 acquired by video cameras included in vehicle 110 and processed to determine feature points 508, 510, 512, 514, respectively. Images 400, 402, 404, 406 that include feature points 508, 510, 512, 514 are referred to as feature maps. Feature points 508, 510, 512, 514 are indicated by circles in images 400, 402, 404, 406 and are determined by inputting images 400, 402, 404, 406 to a first neural network 1106 as described in relation to FIG. 11 below. First neural network 1106 is a convolutional neural network that includes convolutional layers followed by fully connected layers. Convolutional layers extract latent variables that indicate locations of feature points by convolving input images 400, 402, 404, 406 with a series of convolution kernels. Latent variables are input to fully connected layers that determine feature points 508, 510, 512, 514 by combining the latent variables using linear and non-linear functions. Convolution kernels and the linear and non-linear functions are programmed using weights determined by training the first neural network 1106.

Training a neural network 1106 includes determining a training dataset of images that include ground truth. Ground truth includes the true vehicle pose for the vehicle 110. Ground truth is determined based on techniques independent from the neural network 1106. For example, ground truth feature points can be determined by processing the images in the training dataset using image processing software to detect feature points. Examples of feature point detection are included in the Feature Detection and Extraction portion of the Computer Vision Toolbox included in the MatLab software library produced by Math Works, Natick, MA 01760. Training a neural network 1106 to detect feature points 508, 510, 512, 514 can include inputting images from a training dataset multiple times, where for each pass the output from the neural network 1106 are the deep features, that are used to estimate vehicle pose. To train the network, the re-projection error of the estimated pose can be compared to ground truth data to determine a loss function which indicates how close the output is to the correct result. Based on the loss function, the weights that control the convolution kernels and linear and non-linear functions are adjusted. The neural network 1106 training is complete when weights are determined that minimize the loss function over the training dataset.

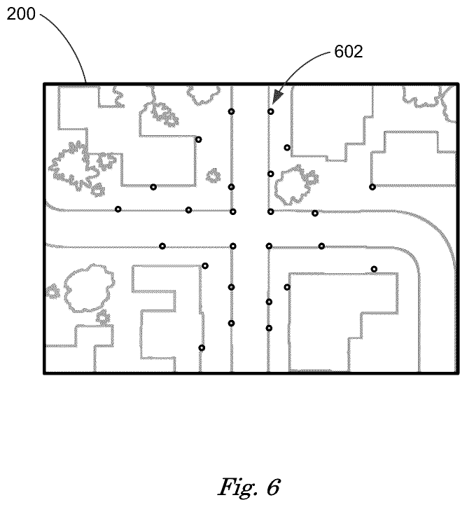

FIG. 6 is a diagram of a satellite image 200 that includes satellite feature points 602 extracted from satellite image 200. Satellite image 200 combined with satellite feature points 602 is referred to as a satellite feature map. Satellite feature points 602 are indicated by circles and are determined by inputting the satellite image 200 to a second neural network 1108 as described in relation to FIG. 11, below. Second neural network 1108 can be the same convolutional neural network architecture as first neural network 1106 and can share the same weights due to similarities in training caused by similarities in the images included in the training datasets used to train the first and second neural networks 1106, 1108. Similarities exist in training the first and second neural networks 1106, 1108 because the same feature extraction software is used in each training process to determine features for inclusion in the ground truth data. In examples of techniques described herein, the first and second neural networks 1106 and 1108 can be the same network, with images being processed serially. Satellite image guided geo-localization techniques as described herein can depend upon determining a portion of feature points from both video images 400, 402, 404, 406 acquired by a vehicle 110 and satellite images 200 that indicate the same locations in global coordinates within a small user-determined tolerance. The tolerance value can be determined by comparing the locations of feature points 508, 510, 512, 514, 602 produced in response to processing the training dataset images with trained first and second neural networks 1106, 1108.

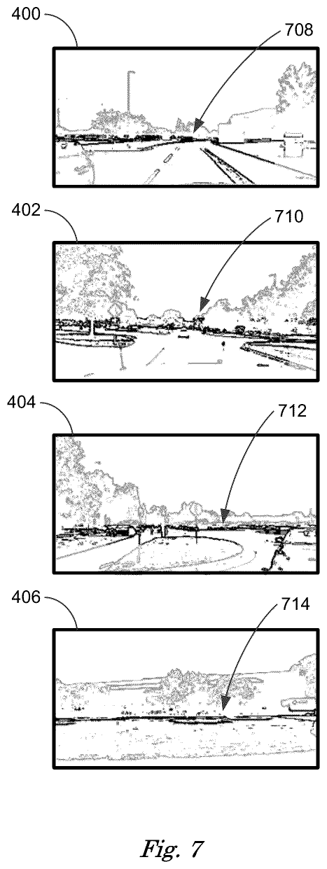

FIG. 7 is a diagram of images 400, 402, 404, 406 that included confidence maps 708, 710, 712, 714, respectively. Confidence maps 708, 710, 712, 714, indicated by dark pixels in images 400, 402, 404, 406, indicate the probabilities that pixel data included in images 400, 402, 404, 406 occur on a ground plane. A ground plane in this context is a plane that is coincident with roadways or other surfaces that support vehicles such as parking lots. Confidence maps 708, 710, 712, 714 can be output by first neural network 1106, which can be trained to output confidence maps in a similar fashion as feature points 508, 510, 512, 514. Training the first neural network 1106 does not require ground truth confidence maps or points on the ground. The first neural network 1106 can be trained in an unsupervised manner. This is an advantage of this technique since it does not require additional annotations for training first neural network 1106.

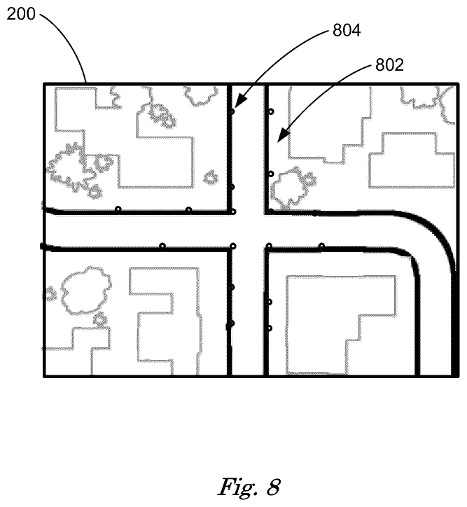

FIG. 8 is a diagram of a satellite image 200 that includes a satellite confidence map 802. Satellite confidence map 802 is indicated by dark pixels in image 200. Satellite confidence map 802 indicates the probability that pixel data included satellite image 200 is included in a ground plane. An example of pixel data included in satellite image 200 that has a high probability of being included in a ground plane are pixels that occur on roadways 202. Training the second neural network 1108 does not require ground truth confidence maps or points on the ground. The second neural network 1108 can be trained in an unsupervised manner. This is an advantage of this technique since it does not require additional annotations for training second neural network 1106. The satellite confidence map 802 can be combined with satellite feature points 602 to generate satellite 3D key feature points 804 that occur on the ground plane of satellite image 200. Global coordinate data included in the satellite image 200 can be used to determine global coordinate data for the satellite 3D key feature points 804.

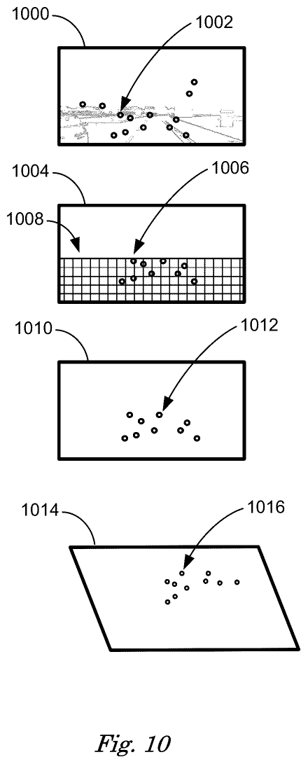

First and second neural networks 1106, 1108 are trained to output both feature points 508, 510, 512, 514, 602 and confidence maps 708, 710, 712, 714, 802 to permit satellite image guided geo-localization techniques to filter out all feature points 508, 510, 512, 514, 602 that do not lie on a ground plane. As mentioned above, first and second neural networks 1106, 1108 can be the same network. This is described in relation to FIG. 10. First and second neural networks 1106, 1108 are also trained to filter out feature points generated by dynamic objects such as vehicles and pedestrians. This can be learned via unsupervised learning and does not require ground truth. Unsupervised learning does not require ground truth to determine loss functions but rather compares the output data to the input data to determine losses. Dynamic objects can occur in either video images 400, 402, 404, 406 or satellite images 200 but cannot be depended upon to reoccur reliably. Because they cannot be depended upon to reoccur reliably, eliminating them from the process increases reliability and accuracy of satellite image guided geo-localization techniques.

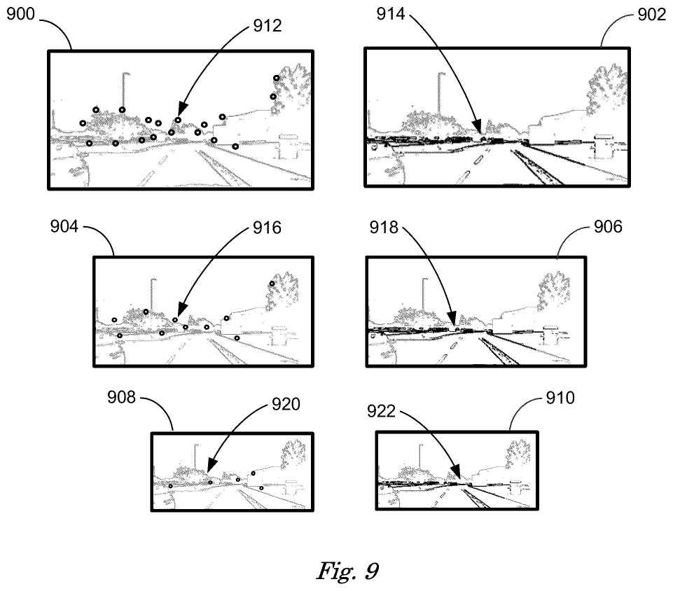

FIG. 9 is a diagram of six images 900, 902, 904, 906, 908, 910 at full resolution and two reduced resolutions. Images 900, 902 include feature points 912 and confidence maps 914, respectively. Images 900, 902 are processed by first neural network 1106 at the resolution at which they were acquired, for example approximately 2K×1K. Images 904, 906 include feature points 916 and confidence maps 918, respectively. Images 904, 906 are processed by first neural network at a reduced resolution, which can be approximately 1K×0.5K, for example. Images 908, 910 include feature points 920 and confidence maps 922, respectively. Images 908, 910 are processed by first neural network at a second reduced resolution, which can be approximately 0.5K×0.25K, for example.

Images 904, 906, 908, 910 can be generated from an image 400, 402, 404, 406 at the full resolution at which it was acquired by decimation, where a single pixel out of a neighborhood of pixels is selected to represent the neighborhood in the lower resolution images. A neighborhood can be 2×2 pixels, for example, which would reduce the resolution of the input image by a factor of two in height and width and reduce the number of pixels by four. Images 904, 906, 908, 910 can alternatively be generated from an image 400, 402, 404, 406 at the original resolution at which it was acquired by pixel averaging, where a single pixel out of a neighborhood of pixels is determined to represent the neighborhood in the lower resolution images by averaging the pixel values in the neighborhood. A neighborhood can again be 2×2 pixels, for example, which would reduce the resolution of the input image by a factor of two in height and width and reduce the number of pixels by four. Pixel averaging can produce a more accurate reduced resolution image typically at an increased use of computational resources.

Satellite image guided geo-localization techniques as described herein uses reduced resolution images 904, 906, 908, 910 to increase accuracy and reliability s a result of being able to learn descriptive feature representations in multi-scale/resolution setting. The algorithms described above in relation to FIG. 5 that select feature points 912, 916, 920 are based on image resolution. For example, the algorithms that select feature points 912, 916, 920 all require a minimum pixel distance between selected points. The lower the resolution, the fewer the selected points. Reducing resolution also reduces the number of locations in an image that would appear to the algorithm as a feature point 912, 916, 920, also reducing the number of feature points selected by first neural network 1106. In similar fashion, first neural network 1106 determines fewer locations in reduced resolution images as confidence maps 914, 918, 922.

Satellite image guided geo-localization techniques as described herein combine the output reduced resolution images 904, 906, 908, 910 with full resolution images 900, 902, respectively by increasing the resolution of the lowest resolution images 908, 910 by pixel replication and ANDing them the next higher resolution images 904, 906, respectively. The resulting images are increased in resolution to the next higher resolution and by pixel replication and ANDed with the next higher resolution images 900, 902 to produce output images. The output images will include only feature points 912 and confidence maps 914 that occur in the lower resolution images 904, 906, 908, 910 but at the high resolution locations included in high resolution images 900, 902.

FIG. 10 is a diagram of four images 1000, 1004 1010, 1014 that illustrate post-processing techniques applied to full resolution output images from FIG. 9. Full resolution output image 1000 including feature points 1002 is combined with full resolution output image 1004 including confidence maps 1008 that exceed a user selected threshold value. Feature points 1002 that fall within the portion of the image 1004 that included confidence maps 1008 that exceed the threshold are retained and all other feature points 1002 are deleted. The user selected threshold value can be determined by examining the confidence maps output from first neural network 1106 for the training dataset.

Image 1010 includes only the feature points 1012 that have been determined to lie on a ground plane. This permits image 1014 to be generated which includes 3D locations of selected k features points 1012 to be included. Determination of 3D locations is possible because points can be found on the ground plane which reduces the problem space. The camera height from the ground is determined by the camera location on the vehicle, which permits location of points on the ground. Restricting the 3D location of points to the ground plane permits scaling data to be determined, particularly in the monocular situation, e.g., when only one camera is used. This also means that the technique described herein does not require multiple cameras or overlapping field of views. The number of key feature points 1016 can be limited to a number k, where k can be 12, for example. Limiting the number of key feature points 1016 can place a bound on compute time required for determining the three DoF pose for the vehicle 110, which can be advantageous for a real time system. 3D locations of k feature points 1016 can be determined based on data regarding the pose of the video camera that acquired the image 1000 (extrinsic camera data) in global coordinates and data regarding a focal point and sensor size of the video camera (intrinsic camera data). Extrinsic and intrinsic camera data can be determined based on data regarding the camera lens and sensor and data regarding the location and orientation of the camera with respect to the vehicle 110 in which it is installed. Extrinsic and intrinsic camera data determine the location and orientation in global coordinates of fields of view 208, 210, 212, 214 of video cameras included in a vehicle 110

Extrinsic and intrinsic camera data can be used to transform the locations of k feature points 1012 in pixel coordinates in an image 1000 into 3D locations in global coordinates. Extrinsic and intrinsic camera data can determine parameters that transform pixel addresses into 3D locations based on projective geometry. Projective geometry includes the mathematical equations that can determine the locations of a single point in two different planes that view the point from two different perspectives. In this example, a data point having a 3D location in global coordinates located on a ground plane is imaged by a camera that transforms the 3D location of a point in global coordinates into a pixel address in an image based on the camera extrinsic and intrinsic data. Satellite image guided geo-localization techniques described herein determine a transformation that projects the pixel coordinates of the k feature points 1012 into 3D locations in global coordinates determine global coordinates of 3D key feature points 1016 by reversing the transformation determined by extrinsic and intrinsic camera data that formed the image 1000. Determining the global coordinates of 3D key feature points 1016 depends upon determining that the k feature points 1012 lie on a ground plane.

As will be discussed in relation to FIG. 11, below, satellite image guided geo-localization techniques iteratively refine the estimate of the 3D locations of the key feature points 1016 by determining loss functions based on the difference between the 3D locations of the key feature points 1016 and satellite 3D key feature points 804 determined based on a satellite image 200. The satellite 3D key feature points 804 are determined by combining the satellite feature points 602 with confidence map 802 to filter locations of satellite feature points 602 to eliminate satellite feature points 602 that do not lie in a ground plane. At each step of the iteration the loss functions are used to update the estimate of the estimated three DoF pose 302 of the vehicle 110. The updated estimate of the estimated three DoF pose 302 of the vehicle 110 is used to reproject the feature points 1012 onto 3D locations of the key feature points 1016 until the loss functions are less than a user determined threshold. The user determined threshold can be determined by examination of results from the training dataset.

FIG. 11 is a diagram of a satellite image guided geo-localization system 1100 as described herein. The satellite image guided geo-localization system can be executed on a computing device 115 included in a vehicle 110. The satellite image guided geo-localization system can input images 1102 from vehicle sensors and satellite images 1104 from computing device 115 memory or downloaded from the Internet and outputs a high definition estimated three DoF pose 1122 for a vehicle 110. Processing begins by inputting images 1102 from video cameras included in a vehicle 110 to a first neural network 1106. First neural network 1106 outputs images 900, 902, 904, 906, 908, 910 including feature points 912, 916, 920 and confidence maps 914, 918, 922 at three or more resolutions to an on ground key point detector 1110 which selects k feature points from each video camera based on feature points 912, 916, 920 from three or more different resolution images 900, 904, 908 based on three or more different resolution confidence maps 902, 906, 910 as discussed above in relation to FIG. 9. The three different resolution images 900, 904, 908 and confidence maps 902, 906, 910 are combined to form a single image 1010 with k key feature points 1012 as discussed in relation to FIG. 10. This is referred to as on-ground key point detection.

In parallel with inputting images 400, 402, 404, 406 to first neural network 1106, a satellite image 200 is input to second neural network 1108. As described above, first and second neural networks 1106, 1108 can be the same network. The satellite image 200 can be selected based on the estimated three DoF pose 302 of the vehicle 110 and recalled from memory or downloaded from the Internet to computing device 115. Satellite image 200 can be processed by second neural network 1108 to determine satellite feature points 602 and confidence map 802 and output to satellite feature point detector 1112.

Satellite feature point detector 1112 determines satellite 3D key feature points 804 from satellite feature points 602 and confidence map 802. Satellite 3D key feature points 804 are determined by using global coordinate location data included in the satellite image data. Satellite 3D key feature points 804 are determined to be included in a ground plane because they have been filtered based on a confidence map 802 that determines portions of the satellite images that lie on the ground plane. 3

Geometric projection can be used to determine a correspondence between the k key feature points and the satellite 3D key feature points 804. The correspondence between the k key feature points and the satellite 3D key feature points 804 is determined by iteratively projecting the k key feature points and the satellite 3D key feature points 804 at 3D projector 1114. 3D projector 1114 determines 3D locations of k filtered and selected feature points in global coordinates based on extrinsic and intrinsic data of the video camera that acquired the acquired the k filtered and selected feature points as described above in relation to FIG. 10. Geometric projection using 3D projector 1114 begins with an initial estimate of the estimated three DoF pose 302 of the vehicle 110 obtained from vehicle sensors. The estimated three DoF pose 302 is used to project the k filtered and selected feature points into 3D global coordinates to determine 3D key feature points 1016. On subsequent iterations, the estimated three DoF pose 302 is updated based on loss functions determined by pose aware branch 1116 loss function and recursive pose refine branch 1118 loss function and updated 3D key feature points 1016 generated for the k filtered and selected feature points for each video image 400, 402, 404, 406.

Because the 3D projection process and the loss functions determined by pose aware branch 1116 and recursive pose refine branch 1118 are differentiable, 3D projector 1114 can determine which direction or directions along the respective three DoF axes to move to decrease the summed distance between the 3D key feature points 1016 and the 3D satellite key points 804 on each iteration. In addition, because global coordinates of 3D feature points and 3D satellite feature points are used to determine the three DoF pose of the vehicle 110, there is no restriction on the number and fields of view 208, 210, 212, 214 of the video images 400, 402, 404, 406. The fields of view 208, 210, 212, 214 can overlap and cover any subset of the environment around a vehicle 110.

Following 3D projector 1114, the combined 3D feature points 1016 and satellite 3D key feature points 804 are input to two separate loss functions. Pose aware branch 1116 is used during training to determine triplet loss for the combined 3D feature points and satellite 3D key feature points 804. The initial pose is used as the incorrect pose and the ground truth pose is used as the correct pose in a triplet loss setting. The pose aware branch 1116 differentiates between the feature residuals obtained using these two poses. The losses are backpropagated to the feature extractor which enables it to learn features that are sensitive to pose. The objective of the pose aware branch 1116 is to create a distinction between the correct pose from the wrong ones in the feature representation space.

The second loss function is determined by recursive pose refine branch 1118. Recursive pose refine branch 1118 optimizes the three DoF pose of the vehicle 110 by inputting the 3D feature points 1016 and satellite 3D key feature points 804 to a differentiable Levenberg-Marquardt algorithm and recursively minimizing a residual formed by determining a re-projection loss based on the estimated pose. The differentiable Levenberg-Marquardt algorithm determines a loss function based on the distance between the 3D feature points 1016 and satellite 3D key feature points 804 based on determining a summed square difference between closest pairs of points from the two sets of point data and calculating a residual. In addition, the Levenberg-Marquardt algorithm is differentiable, which permits the recursive pose refine branch to determine which directions in each of the three DoF axes to move to make the loss function on the next iteration smaller. The results of the pose aware branch 1116 and the recursive pose refine branch 1118 are added together at adder 1120 and fed back to on ground key point detector 1110 and satellite key feature points 1112 to adjust the three DoF pose of the vehicle 110 and reproject the feature points 1012 to form a new set of key feature points 1016 to be combined with the satellite key feature points 1112 at 3D projector 1114 and begin the next iteration. When the combined loss function output by adder 1120 is less than a pre-determined threshold, the satellite image guided geo-localization system 1100 stops iterating and the current estimated three DoF pose 302 is output as a high definition estimated three DoF pose 1122.

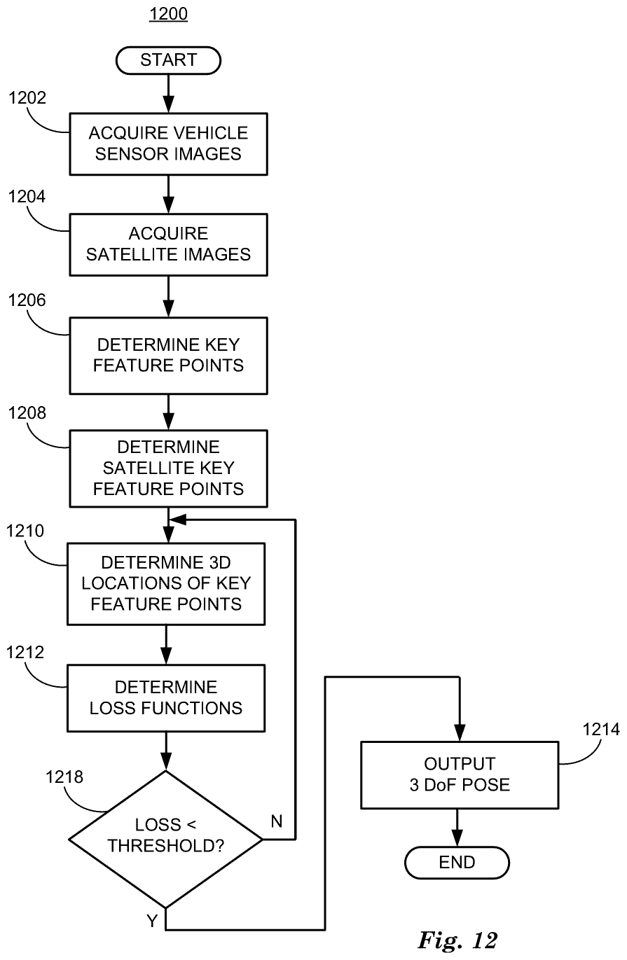

FIG. 12 is a flowchart, described in relation to FIGS. 1-11, of a process 1200 for determining a high definition estimated three DoF pose 1122 based on satellite image guided geo-localization. Process 1200 can be implemented in a computing device 115 included in a vehicle 110. Process 1200 includes multiple blocks that can be executed in the illustrated order. Process 1200 could alternatively or additionally include fewer blocks or can include the blocks executed in different orders.

Process 1200 begins at block 1202 where a computing device 115 in a vehicle 110 acquires images 400, 402, 404, 406 from one or more video cameras included in the vehicle 110. The one or more images 400, 402, 404, 406 include image data regarding an environment around the vehicle 110 and can include any portion of the environment around the vehicle including overlapping field of view 208, 210, 212, 214 as long as the images 400, 402, 404, 406 include data regarding a ground plane, where the ground plane is a plane coincident with a roadway or surface that supports the vehicle 110.

At block 1204 computing device 115 acquires a satellite image 200. The satellite image 200 can be acquired by downloading the satellite image 200 from the Internet via network 130, for example. The satellite image 200 can also be recalled from memory included in computing device 115. Satellite images 200 include location data in global coordinates that can be used to determine the location in global coordinates of any point in the satellite image 200. Satellite image 200 can be selected to include an estimated three DoF pose 302. The estimated three DoF pose 302 can be determined by acquiring data from vehicle sensors 116, for example GPS.

At block 1206 computing device 115 inputs the acquired images 400, 402, 404, 406 to a trained first neural network 1106. The first neural network 1106 can be trained on a server computer 120 and transmitted to a computing device 115 in a vehicle 110. First neural network 1106 inputs images 400, 402, 404 406 and outputs feature points 508, 510, 512, 514 and confidence maps 708, 710, 712, 714 as described above in relation to FIGS. 5 and 7. The feature points 508, 510, 512, 514 and confidence maps 708, 710, 712, 714 are combined as discussed in relation to FIG. 10 to determine k key feature points 1012.

At block 1208 computing device 115 inputs an acquired satellite image 200 and outputs satellite feature points 602 and a satellite confidence map 802 as described above in relation to FIGS. 6 and 8. The satellite feature points 602 and satellite confidence map 802 are combined to determine satellite 3D key feature points 804 as describe in relation to FIGS. 8 and 10, above.

At block 1210 computing device 115 determines 3D key feature points 1016 by projecting k key feature points 1012 onto the ground plane of satellite image 200 using projective geometry and camera extrinsic and intrinsic data as described above in relation to FIG. 10. The initial iteration of block 1210 uses the estimated three DoF pose 302 from vehicle sensor 116 data. Subsequent iterations of process 1200 enhance the estimated three DoF pose 302 by reducing a global loss function that determines geometric correspondence between locations of the 3D key feature points 1016 and the 3D satellite key feature points 804. Geometric correspondence is the process by which the data points in the 3D key feature points 1016 and the 3D satellite key feature points 804 are paired and the entire set of 3D key feature points 1016 is iteratively reprojected to minimize the pairwise error or difference in location of each pair of data points.

At block 1212 computing device 115 determines a pose aware branch 1116 loss function and a recursive pose refine branch 1118 loss function. The two values respectively output from these functions are added to form a global loss function and compared to predetermined threshold to determine whether process 1200 has converged to a solution. If the global loss function is greater than the threshold, process 1200 loops back to block 1210, where the cumulative results are differentiated to determine the directions in which to change each of the three DoF parameters of the estimated three DoF pose 302 to reduce the loss function on the next iteration. The k key feature points 1012 are reprojected using the new estimated three DoF pose 302 to form a new set of 3D key feature points 1016 and the new geometric correspondence between the new set of 3D key feature points 1016 and the 3D satellite key feature points 804 to determine a new global loss function. When the global loss function is less than the threshold, process 1200 has generated a high definition estimated three DoF pose 1122 and process 1200 passes to block 1214.

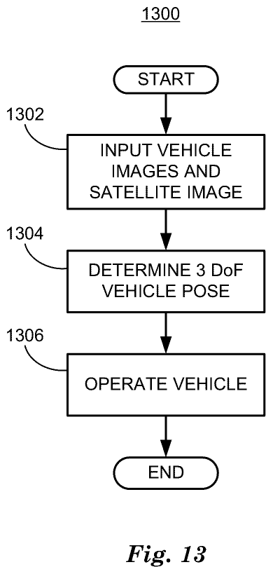

At block 1214 computing device 115 outputs the high definition estimated three DoF estimated pose 1122 to be used to operate vehicle 110 as described in relation to FIG. 13, below. Following block 1214 process 1200 ends.

FIG. 13 is a flowchart, described in relation to FIGS. 1-12 of a process 1300 for operating a vehicle 110 based on a high definition estimated three DoF pose 1122 determined based on a satellite image guided geo-localization system 1100. Process 1200 can be implemented by computing device 115 included in a vehicle 110. Process 1300 includes multiple blocks that can be executed in the illustrated order. Process 1300 could alternatively or additionally include fewer blocks or can include the blocks executed in different orders.

Process 1300 begins at block 1302, where a computing device 115 in a vehicle 110 acquires one or more images 400, 402, 404, 406 from one or more video cameras included in a vehicle 110 and acquires a satellite image 200 by downloading via a network 130 or recalling from memory included in computing device 115. An estimated three DoF pose 302 for vehicle 110 is determined based on data acquired by vehicle sensors 116.

At block 1304 computing device 115 enhances the estimated three DoF pose 302 to a high definition estimated three DoF pose 1122 by processing the one or more images 400, 402, 404, 406 and the satellite image 200 with a satellite image guided geo-localization system 1100 as described in relation to FIG. 11

At block 1306 computing device uses the high definition estimated three DoF pose 1122 to determine a vehicle path for a vehicle 110. A vehicle can operate on a roadway based on a vehicle path by determining commands to direct the vehicle's powertrain, braking, and steering components to operate the vehicle so as to travel along the path. A vehicle path is typically a polynomial function upon which a vehicle 110 can be operated. Sometimes referred to as a path polynomial the polynomial function can specify a vehicle location (e.g., according to x, y and z coordinates) and/or pose (e.g., roll, pitch, and yaw), over time. That is, the path polynomial can be a polynomial function of degree three or less that describes the motion of a vehicle on a ground surface. Motion of a vehicle on a roadway is described by a multi-dimensional state vector that includes vehicle location, orientation, speed, and acceleration. Specifically, the vehicle motion vector can include positions in x, y, z, yaw, pitch, roll, yaw rate, pitch rate, roll rate, heading velocity and heading acceleration that can be determined by fitting a polynomial function to successive 2D locations included in the vehicle motion vector with respect to the ground surface, for example. Further for example, the path polynomial p(x) is a model that predicts the path as a line traced by a polynomial equation. The path polynomial p(x) predicts the path for a predetermined upcoming distance x, by determining a lateral coordinate p, e.g., measured in meters:

$$p ( x ) = {a}_{0} + {a}_{1} x + {a}_{2} {x}^{2} + {a}_{3} {x}^{3} \qquad ( 1 )$$

where a₀ an offset, i.e., a lateral distance between the path and a center line of the vehicle 105 at the upcoming distance x, a₁ is a heading angle of the path, a₂ is the curvature of the path, and @3 is the curvature rate of the path.

The polynomial function can be used to direct a vehicle 110 from a current location indicated by the high definition estimated three DoF pose 1122 to another location in an environment around the vehicle while maintaining minimum and maximum limits on lateral and longitudinal accelerations. A vehicle 110 can be operated along a vehicle path by transmitting commands to controllers 112, 113, 114 to control vehicle propulsion, steering and brakes. Following block 1306 process 1300 ends.

Computing devices such as those described herein generally each includes commands executable by one or more computing devices such as those identified above, and for carrying out blocks or steps of processes described above. For example, process blocks described above may be embodied as computer-executable commands.

Computer-executable commands may be compiled or interpreted from computer programs created using a variety of programming languages and/or technologies, including, without limitation, and either alone or in combination, Java™, C, C++, Python, Julia, SCALA, Visual Basic, Java Script, Perl, HTML, etc. In general, a processor (i.e., a microprocessor) receives commands, i.e., from a memory, a computer-readable medium, etc., and executes these commands, thereby performing one or more processes, including one or more of the processes described herein. Such commands and other data may be stored in files and transmitted using a variety of computer-readable media. A file in a computing device is generally a collection of data stored on a computer readable medium, such as a storage medium, a random access memory, etc.

A computer-readable medium (also referred to as a processor-readable medium) includes any non-transitory (i.e., tangible) medium that participates in providing data (i.e., instructions) that may be read by a computer (i.e., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

The term “exemplary” is used herein in the sense of signifying an example, i.e., a candidate to an “exemplary widget” should be read as simply referring to an example of a widget.

The adverb “approximately” modifying a value or result means that a shape, structure, measurement, value, determination, calculation, etc. may deviate from an exactly described geometry, distance, measurement, value, determination, calculation, etc., because of imperfections in materials, machining, manufacturing, sensor measurements, computations, processing time, communications time, etc.

In the drawings, the same candidate numbers indicate the same elements. Further, some or all of these elements could be changed. With regard to the media, processes, systems, methods, etc. described herein, it should be understood that, although the steps or blocks of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

1. A system, comprising:
a computer that includes a processor and a memory, the memory including instructions executable by the processor to:
determine a first feature map and a first confidence map from a ground view image with a first neural network;
determine first feature points based on the first feature map and the confidence map;
determine first three-dimensional (3D) feature locations based on the first feature points and the first confidence map;
determine second feature points and a second confidence map from an aerial image with a second neural network;
determine second 3D feature locations based on the first 3D feature locations, the second feature points and the second confidence map; and
determine a high definition estimated three degree-of-freedom (DoF) pose of a ground view camera in global coordinates by iteratively determining geometric correspondence between the first 3D feature locations and the second 3D feature locations until a global loss function is less than a user determined threshold.

2. The system of claim 1, wherein the instructions include further instructions to determine the geometric correspondence between pairs of the first 3D feature locations and the second 3D locations by transforming the first 3D feature locations based on a geometric projection which begins with an initial estimate of the three DoF pose of the ground view camera.

3. The system of claim 1, wherein the instructions include further instructions to determine the global loss function by summing 1) a pose aware branch loss function determined by calculating a triplet loss between the first 3D feature locations and the second 3D feature locations and 2) a recursive pose refine branch loss function determined by calculating a residual between the first 3D feature locations and the second 3D feature locations using a Levenberg-Marquardt algorithm.

4. The system of claim 3, wherein the pose aware branch loss function determines a feature residual based on the determined three DoF pose of the ground view camera and the ground truth three DoF pose.

5. The system of claim 4, wherein the global loss is differentiated to determine a direction in which to change the three DoF pose of the ground view camera.

6. The system of claim 5, wherein the global loss is differentiated to determine a direction in which to change the three DoF pose of the ground view camera based on recursively minimizing the residual with the Levenberg-Marquardt algorithm followed by determining a re-projection loss based on an estimated pose.

7. The system of claim 1, wherein the estimated three degree-of-freedom (DoF) pose of the ground view camera in global coordinates are determined based on the aerial image.

8. The system of claim 1, wherein the first confidence map includes probabilities that features included in the ground view image are included in a ground plane.

9. The system of claim 1, wherein the second confidence map includes probabilities that features included in the aerial image are included in a ground plane.

10. The system of claim 1, wherein the first and second neural networks are convolutional neural networks that includes convolutional layers and fully connected layers.

11. The system of claim 1, wherein the aerial image is a satellite image.

12. The system of claim 1, wherein one or more reduced resolution images are generated based on the ground view image at full resolution and the first features are determined by requiring that the first features occur in each of the ground view image at full resolution and the one or more reduced resolutions.

13. The system of claim 1, wherein an initial estimate for a three DoF pose of the ground view camera is determined based on vehicle sensor data.

14. The system of claim 1, wherein the high definition estimated three DoF pose of the ground view camera is output and used to operate a vehicle.

15. The system of claim 14, wherein the high definition estimated three DoF pose of the ground view camera and the aerial image are used to determine a vehicle path upon which to operate the vehicle.

16. A method, comprising:
determining a first feature map and a first confidence map from a ground view image with a first neural network;
determine first feature points based on the first feature map and the confidence map;
determining first three-dimensional (3D) feature locations of the first features based on the first features and the first confidence map;
determining a second features map and a second confidence map from an aerial image with a second neural network;
determining second 3D feature locations based on the first 3D features, the second feature map and the second confidence map; and
determining a high definition estimated three degree-of-freedom (DoF) pose of a ground view camera in global coordinates by iteratively determining geometric correspondence between the first 3D feature locations and the second 3D feature locations until a global loss function is less than a user determined threshold.

17. The method of claim 16, further comprising determining the geometric correspondence between pairs of the first 3D feature locations and the second 3D locations by transforming the first 3D locations based on a geometric projection which begins with an initial estimate of the three DoF pose of the ground view camera.

18. The method of claim 16, further comprising determining the global loss function by summing 1) a pose aware branch loss function determined by calculating a triplet loss between a transformed first 3D feature locations and the second 3D feature locations and 2) a recursive pose refine branch loss function determined by calculating a residual between the transformed first 3D feature locations and the second 3D feature locations using a Levenberg-Marquardt algorithm.

19. The method of claim 18, wherein the pose aware branch loss function determines a feature residual based on the determined three DoF pose of the ground view camera and the ground truth three DoF pose.

20. The method of claim 19, wherein the global loss is differentiated to determine a direction in which to change the estimated three DoF pose of the ground view camera.
